(19) United States
(12) Patent Application Publication
(10) Pub. No.: US 2012/0300154 A1
(43) Pub. Date: Nov. 29, 2012

(54) SURFACE LIGHT SOURCE DEVICE AND LIQUID CRYSTAL DISPLAY DEVICE EQUIPPED WITH SAME

(75) Inventor: Shigenori Tanaka, Osaka-shi (JP)

(73) Assignee: SHARP KABUSHIKI KAISHA, Osaka-shi, Osaka (JP)

(21) Appl. No.: 13/576,499

(22) PCT Filed: Nov. 16, 2010
(86) PCT No.: PCT/JP2010/070397

§ 371 Date: Aug. 1, 2012

(30) Foreign Application Priority Data
Feb. 18, 2010 (JP) 2010-033321

(51) Int. Cl. G02F 1/13357; F21V 8/00

(52) U.S. Cl. 349/58; 362/633

(57) ABSTRACT

The surface light source device (1) includes a light guide plate (2), a resin frame (3), an optical frame (4), a reflecting film (5), and a light source (not illustrated). The light guide plate (2) and the optical frame (4) are provided within the resin frame (3) on the reflecting film (5). At least part, of at least a side surface of the resin frame (3) which faces a side surface of the light guide plate (2), is (i) a inclined surface which is inclined with respect to a direction perpendicular to a light exit surface or (ii) a curved surface which is curved with respect to a direction perpendicular to the light exit surface. Further, the inclined surface or the curved surface looks towards the light exit surface. The light, which has leaked out of the side surface of the light guide plate (2), is reflected from the inclined surface or the curved surface of the resin frame (3) so as to be directed towards a liquid crystal panel. This allows the light, which has leaked out of the side surface of the light guide plate (2), to be reflected towards the liquid crystal panel.

### TECHNICAL FIELD

The present invention relates to surface light source devices and liquid crystal display devices equipped with the surface light source device, in particular, a surface light source device having a high front luminance, and a liquid crystal display device equipped with the surface light source device.

### BACKGROUND ART

Recently, portable information devices, such as a laptop personal computer, a Personal Data Assistant (PDA), a mobile game device, or a mobile phone, have been proliferated widely. Such portable information devices commonly use liquid crystal display device (LCD) as a display. The LCD is fundamentally constituted by a backlight section and a liquid crystal display element section. The LCD thus includes a surface light source device which serves as the backlight section, and a liquid crystal panel which serves as the liquid crystal display element section.

Configurations of a backlight section encompass (i) a direct type in which light sources are provided beneath a LCD, and (ii) an edge-light type in which light sources are provided on side surfaces of a light guide plate. Edge-light type backlights are widely used, taking into consideration its capability to attain a LCD which is thin and lightweight, and has an even luminance. An edge-light type surface light source device is configured such that light sources provided on side surfaces of a light guide plate radiate light to an entire surface of the light guide plate.

FIG. 9 illustrates the detail of a conventional edge-light type surface light source device. (a) of FIG. 9 illustrates a configuration of the conventional surface light source device 11. (b) of FIG. 9 is a cross-sectional view of the conventional surface light source device 11. As illustrated in (a) of FIG. 9, the surface light source device 11 has a configuration in which a bezel 6, a reflecting film 5, a resin frame 3, a light guide plate 2, an optical frame 4, and a light shielding tape 7 are stacked in this order. A light source 8 is (i) provided on a side surface of the light guide plate 2 and (ii) provided on and connected to a flexible substrate 9. In FIG. 9, the optical frame 4 includes two lens sheets 4b between diffusion sheets 4a. Note, however, that there is also an optical frame 4 which does not include one diffusion sheet 4b on a side of the light shielding tape 7. Note, further, that there is also a surface light source device 11 which does not include the bezel 6.

As illustrated (b) of FIG. 9, the surface light source device 11 includes the light guide plate 2 provided in the resin frame 3 on the reflecting film 5, and the light source 8 is provided on a side surface of the light guide plate 2. The optical frame 4 is provided on the light guide plate 2. The light shielding tape 7 is provided on the optical frame 4. The respective components are sealed in the bezel 6. Light emitted from the light source 8, such as a light emitting diode (LED), a semiconductor laser (LD), or a cold cathode fluorescent lamp (CCFL), enters the light guide plate 2 of the surface light source device 11. The light emitted from the light source 8 is subjected to multiple-reflection within the light guide plate 2, and is then emitted outward via a surface (light exit surface) of the light guide plate 2 which surface is located on a liquid crystal panel (not illustrated) side. The light emitted from the light guide plate 2, is converged onto the optical frame 4 so as to illuminate the liquid crystal panel. In this way, the light emitted from the light source 8 (i) is efficiently guided through the light guide plate 2 so as to be directed to a liquid crystal panel side, and (ii) is then converged onto the optical frame 4. As the result, the surface light source device 11 has a uniform illuminance distribution. This allows the liquid crystal panel to be irradiated with a uniform light. The reflecting film 5 is a film for causing light, which has leaked out of the light guide plate 2 towards the reflecting film 5, to reenter the light guide plate 2. The light shielding tape 7 prevents light, which is directed towards the liquid crystal panel by the light guide plate 2, from leaking towards an area which is not needed to be illuminated.

As such, the backlight section of a LCD uses the light guide plate 2 which enables point or line shaped light sources to serve as a surface light source. In order to improve efficiency in the utilization of light of the light guide plate 2, various efforts have been made. For example, Patent Literature 1 discloses a surface light source device including (i) a frame having a very high reflectance, and (ii) basis units provided on a light reflecting surface of the frame, the basis units being of substantially similar shape and each having inclined surfaces. According to the surface light source device of Patent Literature 1, illumination light, which has exited from a bottom of a light guide plate, will be effectively reflected from the inclined surfaces of basis units provided on the light reflecting surface in a normal direction of the light guide plate. In a case where the surface light source device radiates the illumination light in the normal direction of a light emitting surface of the light guide plate, approximately half of light flux is reflected within the light guide plate and then directed towards a front direction from the light guide plate, whereas the remaining components of the light which are not directed towards the normal direction will exit from the bottom (facing the frame) of the light guide plate. The illumination light can effectively be reflected from inclined surfaces of basis units provided on the light reflecting surface in the normal direction of the light guide plate.

### CITATION LIST

### Patent Literature

Patent Literature 1

Japanese Patent Application Publication, Tokukai No. 2003-317521 A (Publication Date: Nov. 7, 2003)

### SUMMARY OF INVENTION

### Technical Problem

The following description will discuss an effective light emitting area of a conventional surface light source device 11 and an active area of a LCD in detail with reference to FIG. 10. FIG. 10 is a schematic diagram illustrating the effective light emitting area 13 of the conventional surface light source device 11 and the active area 12 of the LCD. As illustrated in FIG. 10, the conventional surface light source device 11 has the effective light emitting area 13 which has a size equal to the size of a light guide plate 2 included in the surface light source device 11. It is common that the effective light emitting area 13 is configured to be larger than the active area 12 of the LCD so as to meet (i) a situation in which a displacement between a liquid crystal display element section and a backlight section will occur while they are being combined with each other, and (ii) a situation in which a dimension error will occur during forming of the light guide plate 2. However, a surface light source device 11 has a higher front luminance as a light guide plate 2 has a smaller size. For example, in a case where (i) an LCD is a 4 inch LCD and (ii) a light guide plate 2 has a size equal to the size of an active area 12 of a LCD, there is a rise of 5% in front luminance as compared with a case where a light guide plate 2 is made larger than the active area 12 by about 1 mm. Therefore, the conventional surface light source device 11 has a lower front luminance since it includes the light guide plate 2 (which corresponds to the effective light emitting area 13) which is larger than the active area 12 by about 1 mm of the LCD.

The surface light source device disclosed in Patent Literature 1 has a high level of efficiency in the utilization of illumination light due to the inclined surfaces of basis units provided on the light reflecting surface of the frame. In fact, however, the surface light source device has a low front luminance since it includes a larger light guide plate.

The present invention has been accomplished in view of the problem, and an object of the present invention is to provide a surface light source device having a higher front luminance, and a liquid crystal display device including the surface light source device.

### Solution to Problem

In order to solve the problem, a surface light source device according to the present invention is a surface light source device including: a light source for emitting light; a light guide plate for guiding the light emitted from the light source so as to direct the light outward via a light exit surface of the light guide plate; and a frame in which the light source and the light guide plate are housed, at least part, of at least a side surface of the frame which faces a side surface of the light guide plate, being (i) an inclined surface, which is inclined with respect to a direction perpendicular to the light exit surface or (ii) a curved surface, which is curved with respect to a direction perpendicular to the light exit surface, the inclined surface or the curved surface looking towards the light exit surface.

The light which is emitted from the light source and entered the light guide plate will partially leak out of side surfaces of the light guide plate. A conventional surface light source device is configured such that the light, which has leaked out of the side surfaces of the light guide plate, is reflected from the frame so as to reenter the light guide plate. Note, however, that not all the light, which has leaked out of the side surfaces of the light guide plate, is reflected from the frame so as to reenter the light guide plate. The conventional surface light source device has thus a low level of efficiency in the utilization of light. This causes a front luminance to be low.

According to the surface light source device of the present invention, at least part, of at least a side surface of the frame which faces a side surface of the light guide plate, being (i) an inclined surface, which is inclined with respect to a direction perpendicular to the light exit surface or (ii) a curved surface, which is curved with respect to a direction perpendicular to the light exit surface, the inclined surface or the curved surface looking towards the light exit surface. Therefore, light, which has been leaked out of the side surface of the light guide plate, is reflected from the inclined surface or the curved surface (a reflecting surface) of the frame so as to be directly directed towards the liquid crystal panel. That is, the light emitted from the light source will be directed to the liquid crystal panel also via a region where the reflecting surface of the frame is formed. Therefore, an area (effective light emitting area) of light emitted from the surface light source device will be larger than that of the conventional surface light source device. That is, according to the surface light source device of the present invention, the effective light emitting area is larger than the size of the light guide plate. Therefore, the surface light source device can still have the effective light emitting area larger than an active area of a liquid crystal display device even in a case where a light guide plate is made smaller in the surface light source device than in a conventional one. In other words, according to the surface light source device of the present invention, it is possible to downsize the light guide plate. This allows a light intensity per unit area of the surface light source device to be increased. The surface light source device thus has a higher front luminance. Since the present invention can downsize the light guide plate, it is possible for the surface light source device to have a higher front luminance.

Further, in order to solve the problem, a liquid crystal display device in accordance with the present invention is a liquid crystal display device including the above-mentioned surface light source device and a liquid crystal panel.

According to the configuration, it is possible to attain a liquid crystal display device which includes a surface light source device having a high front luminance.

Other object, features and advantages of the present invention will be appreciated with reference to the description below. Advantages of the present invention will also be appreciated with reference to the description below on the basis of the attached drawings.

### Advantageous Effects of Invention

According to a surface light source device of the present invention, an effective light emitting area is larger than the size of a light guide plate. That is, the surface light source device can still have the effective light emitting area larger than an active area of a liquid crystal display device even in a case where a light guide plate is made smaller in the surface light source device than in a conventional one. In other words, according to the surface light source device of the present invention, it is possible to downsize the light guide plate. This allows light intensity per unit area of the surface light source device to be increased. The surface light source device thus has a higher front luminance. Since the present invention can downsize the light guide plate, it is possible for the surface light source device to have a higher front luminance.

### BRIEF DESCRIPTION OF DRAWINGS

FIG. 1 is a cross-sectional view schematically illustrating a surface light source device of an embodiment of the present invention.

FIG. 2 is a cross-sectional view illustrating a configuration of a liquid crystal display device which employs the surface light source device of the embodiment of the present invention.

FIG. 3 is a schematic diagram illustrating how light, which has exited from a side surface of a light guide plate, is reflected in a conventional surface light source device.

FIG. 4 is a diagram illustrating an example in which a light guide plate is fit into a resin frame, in accordance with an embodiment of the present invention.

FIG. 5 is a diagram illustrating a case where a light guide plate it not fit into a resin frame, in accordance with an embodiment of the present invention.

FIG. 6 is a cross-sectional view illustrating a configuration of a liquid crystal display device which employs a surface light source device in accordance with an embodiment of the present invention, the surface light source including a resin frame whose side surface is partially inclined.

FIG. 7 is a cross-sectional view illustrating a configuration of a liquid crystal display device which employs a surface light source device in accordance with an embodiment of the present invention, the surface light source device including a resin frame whose side surface is curved in a convex manner.

FIG. 8 is a cross-sectional view illustrating a configuration of a liquid crystal display device which employs a surface light source device in accordance with an embodiment of the present invention, the surface light source device including a resin frame whose side surface is curved in a concave manner.

(a) of FIG. 9 illustrates a configuration of a conventional surface light source device, and (b) of FIG. 9 is a cross-sectional view of the conventional surface light source device.

FIG. 10 is a schematic diagram illustrating an effective light emitting area of a conventional surface light source device and an active area of a liquid crystal display device.

### DESCRIPTION OF EMBODIMENTS

### (Outline of Surface Light Source Device 1)

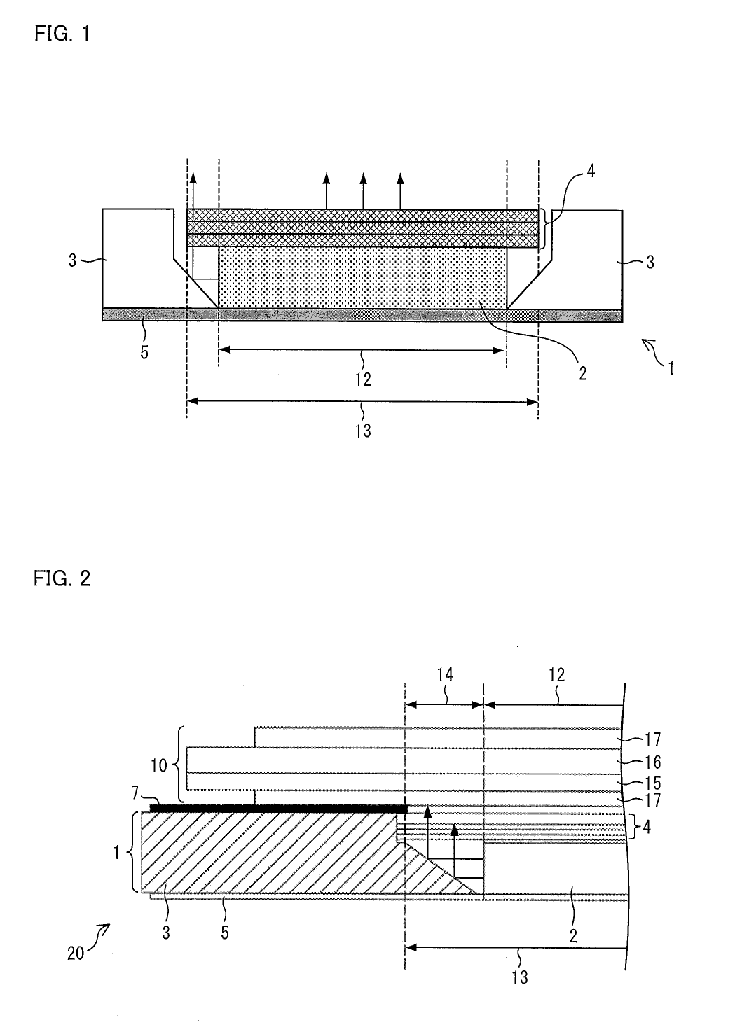

A liquid crystal display device (LCD) is fundamentally constituted by a backlight section and a liquid crystal display element section. The liquid crystal display device thus includes a surface light source device which serves as the backlight section, and a liquid crystal panel which serves as the liquid crystal display element section. The following description will outline the surface light source device of the present embodiment with reference to FIG. 1. FIG. 1 is a cross-sectional view schematically illustrating a surface light source device 1.

As illustrated in FIG. 1, the surface light source device 1 includes a light guide plate 2, a resin frame (frame) 3, an optical frame 4, a reflecting film 5, and light sources (not illustrated). The light guide plate 2 is provided in the resin frame 3 on the reflecting film 5. The optical frame 4 is provided on the light guide plate 2. In the surface light source device 1, for example, a light emitting diode (LED), a semiconductor laser (LD), or a cold cathode fluorescent lamp (CCFL) is employed as the light source. The surface light source device 1 can be of (i) a direct type in which light sources are provided beneath the LCD or (ii) an edge-light type in which light sources are provided on side surfaces of the light guide plate 2. While the light source is emitting light, the light emitted from the light source enters the light guide plate 2 of the surface light source device 1, is subjected to multiple-reflection within the light guide plate 2, and is then emitted outward via a surface (light exit surface) of the light guide plate 2 which surface is located on a liquid crystal panel (not illustrated) side. The light emitted from the light guide plate 2 is converged onto the optical frame 4 so as to illuminate the liquid crystal panel. In this way, the light emitted from the light source (i) is efficiently guided through the light guide plate 2 so as to be directed to a liquid crystal panel side and (ii) is then converged onto the optical frame 4. As the result, the surface light source device 1 has a uniform illuminance distribution. This allows the liquid crystal panel to be irradiated with a uniform light. The reflecting film 5 is a film for causing light, which has leaked out of the light guide plate 2 towards the reflecting film 5, to reenter the light guide plate 2.

According to the surface light source device 1 of the present embodiment, at least a side surface of the resin frame 3 which faces a side surface of the light guide plate 2 is inclined. With the configuration, in a case where the light, which has entered the light guide plate 2, leaks out of the side surface of the light guide plate 2, the light is reflected from the inclined surface of the resin frame 3 so as to be directed towards the liquid crystal panel. This allows an extension of an effective light emitting area of the surface light source device 1. This is because the light, which has leaked out of the side surfaces of the light guide plate 2, is also directed towards the liquid crystal panel (later described in detail). In other words, the surface light source device 1 can still have an effective light emitting area larger than an active area of the LCD, even in a case where a light guide plate 2 is made smaller in the surface light source device 1 than in a conventional one. Since the light guide plate 2 can be downsized, the surface light source device 1 can attain a higher front luminance.

### (Configuration of Surface Light Source Device 1)

The following description will discuss in detail the surface light source device 1 with reference to FIG. 2. FIG. 2 is a cross-sectional view illustrating a configuration of an LCD 20 which employs the surface light source device 1.

As early described, the LCD 20 is constituted by a backlight section and a liquid crystal display element section. As illustrated in FIG. 2, the LCD 20 includes the surface light source device 1 which serves as the backlight section, and a liquid crystal panel 10 which serves as the liquid crystal display element section. The surface light source device 1 and the liquid crystal panel 10 are connected to each other, via a light shielding tape 7. The light shielding tape 7 is provided in order to prevent light, which is directed toward the liquid crystal panel by light guide plate 2, from leaking towards an area which is not needed to be illuminated. When the surface light source device 1 is connected to the liquid crystal panel 10, the light shielding tape 7, which has an adhesive layer, can be used as an adhesive agent tape. Alternatively, a double-face adhesive tape can be used in addition to the light shielding tape 7. The liquid crystal panel 10 includes: (i) a glass substrate 15 which includes a thin film transistor (TFT), wirings, and other elements; (ii) a glass substrate 16 which includes a transparent electrode, a color filter, and other elements; (iii) a layer which is (a) sandwiched between the glass substrates 15 and 16, (b) filled with a liquid crystal material, and (c) sealed; and (iv) polarization plates 17 provided on both sides of the layer.

As early described, the surface light source device 1 includes: the light guide plate 2, the resin frame 3, the optical frame 4, the reflecting film 5, and the light sources (not illustrated). The light guide plate 2 is housed in the resin frame 3 on the reflecting film 5. A side surface of the resin frame 3 which faces a side surface of the light guide plate 2 is inclined. Specifically, it is sufficient that at least part, of at least a side surface of the resin frame 3 which faces a side surface of the light guide plate 2, is inclined with respect to a direction perpendicular to the light exit surface, the inclined surface looking towards the light exit surface. The optical frame 4 is provided on the light guide plate 2, and is supported by the resin frame 3. The optical frame 4 generally includes a lens sheet(s) or a diffusion sheet(s). Examples of the optical frame 4 include (i) an optical frame 4 of biprism type in which two lens sheets are provided between two diffusion sheets, the two lens sheets having respective crossed prism patterns, and (ii) an optical frame 4 of reverse prism type in which one (1) lens sheet with a prism pattern pointing downwards.

The light, which has been emitted from the light source and has entered the light guide plate 2, will partially leak out of (i) a surface of the light guide plate 2 on an opposite side of the liquid crystal panel 10, i.e., the surface facing the reflecting film 5 and (ii) the side surfaces of the light guide plate 2. The light, which has leaked out of the surface facing the reflecting film 5, is reflected from the reflecting film 5 so as to reenter the light guide plate 2. The light thus reentered is subjected to multiple-reflection within the light guide plate 2, so as to be directed towards the side of the liquid crystal panel 10.

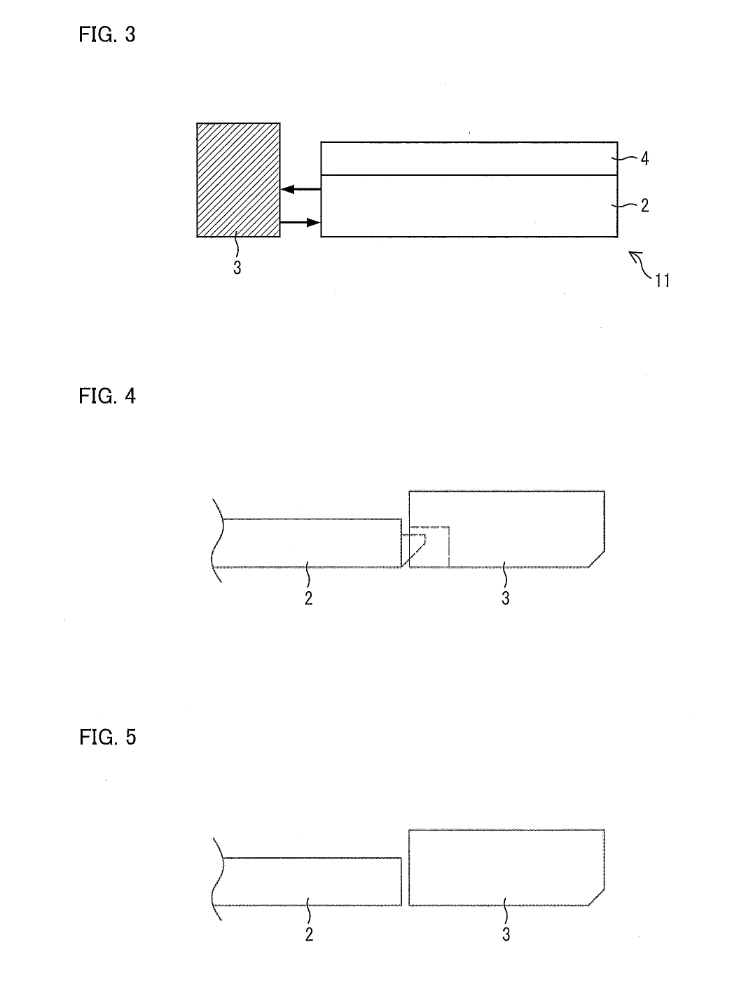

Meanwhile, the light, which has leaked out of the side surfaces of the light guide plate 2, will be directed towards the resin frame 3. According to a conventional configuration, light, which has leaked out of side surfaces of a light guide plate 2, is reflected from a resin frame 3 so as to reenter the light guide plate 2. This will be described below in detail with reference to FIG. 3. FIG. 3 is a diagram schematically illustrating how light, which has leaked out of a side surface of the light guide plate 2, is reflected in a conventional surface light source device 11. As illustrated in FIG. 3, the light, which has leaked out of the side surface of the light guide plate 2, is directed towards the resin frame 3. The light is then reflected from the side surface of the resin frame 3 so as to reenter the light guide plate 2. Note, however, that not all the light, which has leaked out of the side surfaces of the light guide plate 2, is reflected from the side surface of the resin frame 3 so as to reenter the light guide plate 2. As such, the conventional surface light source device 11 has a low level of efficiency in the utilization of light. This causes a front luminance to be low.

In view of the circumstances, according to the surface light source device 1 of the present embodiment, at least part, of a side surface of the resin frame 3 which faces a side surface of the light guide plate 2, is inclined with respect to a direction perpendicular to the light exit surface, the inclined surface looking towards the light exit surface. With the configuration, the light, which has leaked out of the side surface of the light guide plate 2, is reflected from the inclined surface (reflecting surface) of the resin frame 3 so as to be directly directed towards the liquid crystal panel 10. That is, the light emitted from the light source will be directed towards the liquid crystal panel also via a region where the reflecting surface of the frame is formed. Therefore, an area (effective light emitting area 13) of light emitted from the surface light source device 1 of the present embodiment is larger than that of the conventional configuration. According to the conventional configuration, the effective light emitting area 13 has a size equal to the size of the light guide plate 2. In contrast, according to the present embodiment, the effective light emitting area 13 has a size larger than the size of the light guide plate 2. Therefore, the surface light source device 1 can still have the effective light emitting area 13 larger than the active area 12 of the LCD 20 even in a case where a light guide plate 2 is made smaller in the surface light source device 1 than in a conventional one.

For example, in a case where the light guide plate 2 has a size equal to the size of the active area 12 of the LCD 20, the surface light source device 1 can have an effective light emitting area 13 as illustrated in FIG. 1. In contrast, in a case where it is intended to obtain, with the use of the conventional surface light source device 11, such an effective light emitting area 13 illustrated in FIG. 1, it is necessary to prepare a light guide plate 2 equivalent to the effective light emitting area 13. According to the present embodiment, the light guide plate 2 can be downsized, as compared with the conventional light guide plate 2, by an area (an area 14 in FIG. 1) obtained by subtracting the active area 12 of the LCD 20 from the effective light emitting area 13.

Note that the surface light source device 1 has a higher front luminance as the light guide plate 2 has a smaller size. This is based on the following reason. Namely, since a light intensity per unit area becomes larger in a case the light guide plate 2 has a small size, the surface light source device 1 has a higher front luminance. For example, in a case where (i) an LCD 20 is a 4 inch LCD 20 and (ii) a light guide plate 2 has a size equal to the size of an active area 12 of the LCD 20, there is a rise of 5% in front luminance as compared with a case where a light guide plate 2 is made larger than the active area 12 by about 1 mm. Since the present embodiment can downsize the light guide plate 2, it is possible for the surface light source device 1 to have a higher front luminance.

It is common that the effective light emitting area 13 of the surface light source device 1 is larger than the active area 12 of the LCD so as to meet (i) a situation in which a displacement between a liquid crystal display element section and a backlight section will occur while they are being combined with each other and (ii) a situation in which a dimension error will occur during forming of the light guide plate 2. According to the surface light source device 1 of the present embodiment, the light, which is (i) reflected from the inclined surface (reflecting surface) of the resin frame 3 and (ii) then directed toward the liquid crystal panel, has a sufficient luminance. Accordingly, even if a displacement occurs during combining of the liquid crystal panel 10 and the surface light source device 1, then display quality of the LCD 20 will not be adversely affected.

Note that the light guide plate 2 can be made smaller than the active area 12 of the LCD 20. In this case, however, it is preferable to set the size of the light guide plate 2 to an appropriate one, by taking into consideration a good balance between (a) the effective light emitting area 13 of the surface light source device 1 and (b) the active area 12 of the LCD 20.

### (Outline of Resin Frame 3)

It is preferable that a side surface of the resin frame 3 which faces the light guide plate 2 is inclined at an angle of about 30° to 60°, depending on the inch size of the LCD 20. Within such an inclination range, the light which has leaked out of the side surface of the light guide plate 2 can be effectively reflected from the inclined surface so as to be directed towards the liquid crystal panel 10. Note that the resin frame 3 is not necessarily made from a resin. Examples of the material, from which the frame 3 is made, include a sheet metal. Also note that the resin frame 3 is preferably made from a white color material which does not absorb light. The light which has leaked out of the light guide plate 2 can be effectively reflected from the resin frame 3 which is made from the white color material so as to be directed towards the liquid crystal panel 10.

The inclined surface of the resin frame 3 can have concavity and convexity. With the configuration, light, which has leaked out of the side surface of the guide plate 2, can be reflected from the inclined surface of the resin frame 3 while being diffused by the concavity and convexity.

As early described, the surface light source device 1 of the present embodiment can be of (i) a direct type in which light sources are provided beneath the LCD or (ii) an edge-light type in which light sources are provided on side surfaces of the light guide plate 2. Note, however, that, in a case where the surface light source device 1 is of an edge-light type, at least a side surface, of the resin frame 3 which faces a side surface of the light guide plate 2 on which no light source is provided, should be inclined.

Note that the light guide plate 2 can be configured so as to be fitted into and fixed on the resin frame 3. The following description will discuss such a configuration with reference to FIGS. 4 and 5. FIG. 4 illustrates an example in which the light guide plate 2 is fitted into the resin frame 3. FIG. 5 illustrates an example in which the light guide plate 2 is not fitted into the resin frame 3.

In a case where the light guide plate 2 is fitted into the resin frame 3, the light guide plate 2 is provided with a protrusion, and the resin frame 3 is provided with a recess into which the protrusion is fitted (see FIG. 4). Then, the protrusion of the light guide plate 2 is inserted into the recess of the resin frame 3, so that the light guide plate 2 is fitted into the resin frame 3. In this way, the fitting is attained. Note that an entire side surface of the light guide plate 2 which is fitted into the resin frame 3 can be fitted into the resin frame 3. The present embodiment is, however, not limited to this. For examples, part of the side surface of the light guide plate 2 can be fitted into the resin frame 3.

Alternatively, in a case where the light guide plate 2 is not necessarily be fixed on the resin frame 3, the light guide plate 2 can be configured to be supported by the resin frame 3 instead of being fitted into the resin frame 3 (see FIG. 5). In the present embodiment, at least a side surface of the resin frame 3 which faces a side surface of the light guide plate 2 is inclined. Note, however, that the embodiment is not limited to this configuration. For example, it is possible to separately provide an inclined member between (i) a side surface of the resin frame 3 which faces a side surface of the light guide plate 2 and (ii) the side surface of the light guide plate 2.

### Other Embodiments

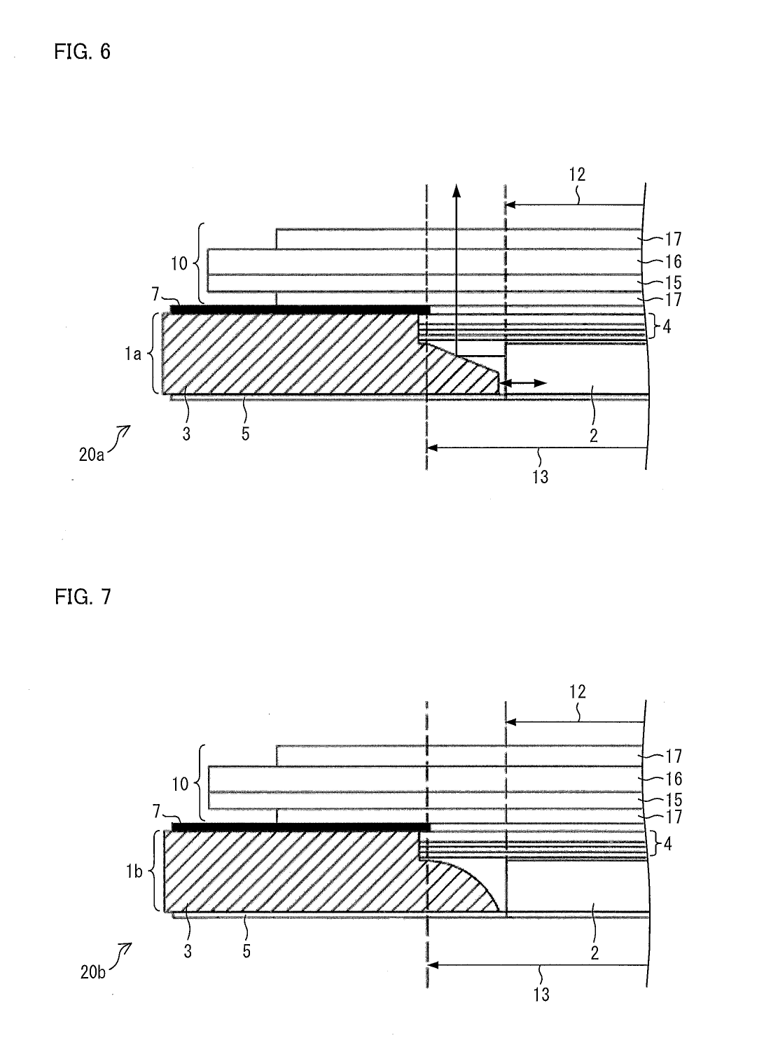

So far, the description has been discussed with regard to the case where an entire side surface, out of the resin frame 3, which faces a side surface of the light guide plate 2, is inclined. Note, however, that the present invention is not limited to this. For example, part of a side surface of the resin frame 3 which faces a side surface of the light guide plate 2 can be inclined. The following description will discuss such a configuration with reference to FIG. 6. FIG. 6 is a cross-sectional view illustrating a configuration of a LCD 20a which employs a surface light source device 1a. The surface light source device la includes a resin frame 3 whose side surface is partially inclined.

In the surface light source device la as illustrated in FIG. 6, a side surface of the resin frame 3, which faces a side surface of the light guide plate 2, is partially inclined. Specifically, the side surface is inclined not in a lower part but in an upper part. According to the configuration, light, which has leaked out of the side surface of the light guide plate 2 and is then directed towards the lower part (not inclined part) of the resin frame 3, is reflected from the resin frame 3 so as to reenter the light guide plate 2. On the other hand, light, which has leaked out of the side surface of the light guide plate 2 and is then directed towards the upper part (inclined part) of the resin frame 3, is (i) reflected from the partially inclined side surface and then (ii) directed towards the liquid crystal panel 10. In this way, a partially inclined side surface of the resin frame 3 which faces a side surface of the light guide plate 2 enables the light which has leaked out of the side surface of the light guide plate 2 to (i) reenter the light guide plate 2 and (ii) be directed towards the liquid crystal panel 10.

Even in the surface light source device la, the light which has leaked out of the side surface of the light guide plate 2 is reflected from the inclined surface (reflecting surface) of the resin frame 3 so as to be directly directed towards the liquid crystal panel 10. That is, the light emitted from the light source will be directed towards the liquid crystal panel, partially via a region where the reflecting surface of the resin frame is formed. An area (effective light emitting area 13) of light emitted from the surface light source device la of the present embodiment is larger than that of the conventional surface light source device. Therefore, the surface light source device 1 can still have the effective light emitting area 13 larger than the active area 12 of the LCD 20 even in a case where a light guide plate 2 is made smaller in the surface light source device 1 than in a conventional one. As the result, since the light guide plate 2 of the surface light source device la can be downsized, the surface light source device la can attain a higher front luminance.

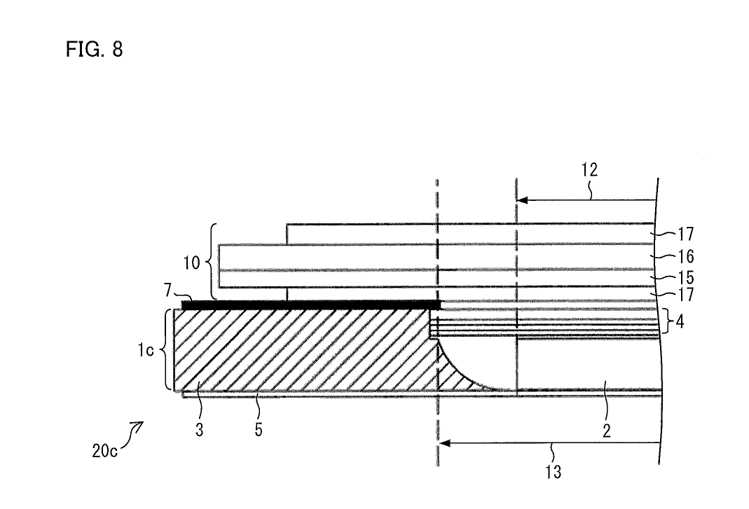

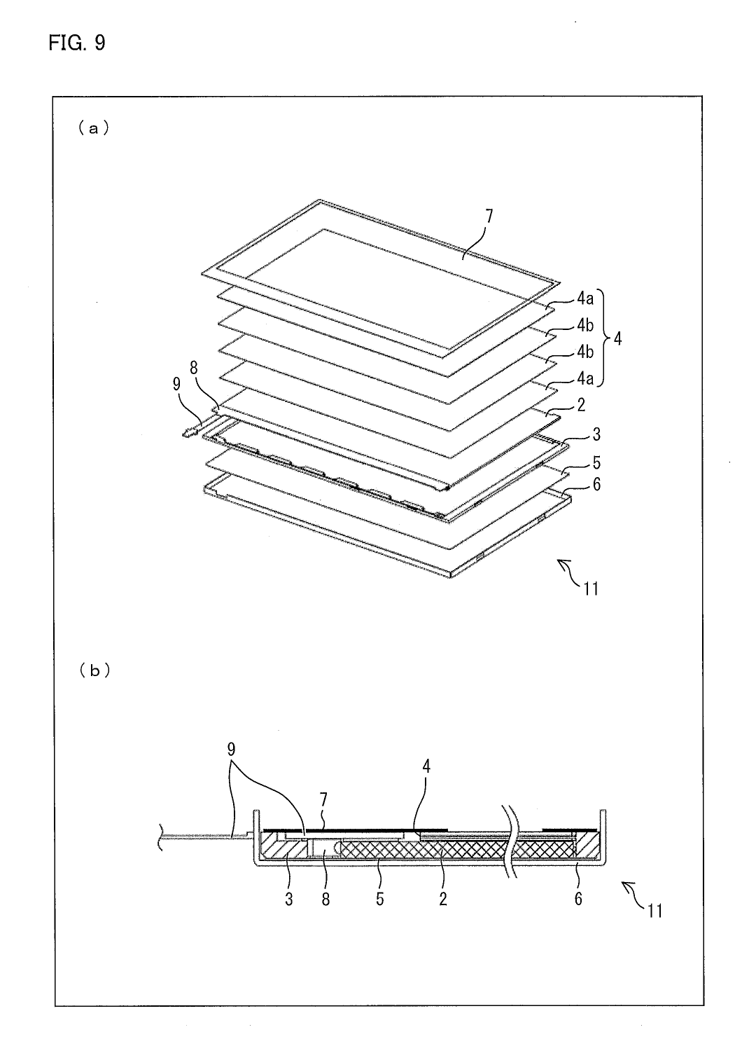

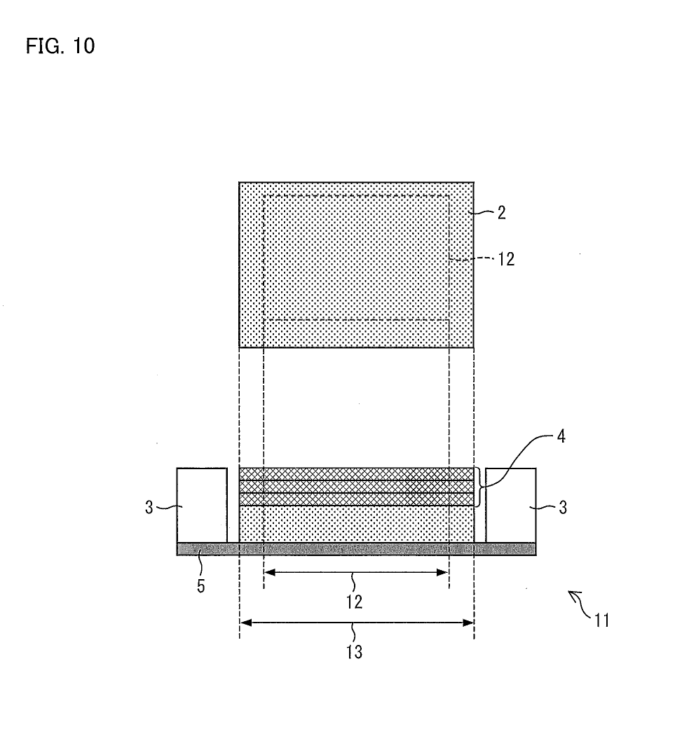

Note that the side surface of the resin frame 3 is not limited to the inclined surface, provided that light, which has leaked out of the side surface of the light guide plate 2, is reflected from the side surface of the resin frame 3 so as to be directed towards the liquid crystal panel 10. For example, the side surface of the resin frame 3 can be a curved surface, instead of the inclined surface. The following description will discuss the curved surface with reference to FIGS. 7 and 8. FIG. 7 is a cross-sectional view illustrating a configuration of a LCD 20b which employs a surface light source device 1b. The surface light source device 1b includes a resin frame 3 whose side surface is curved in a convex manner. FIG. 8 is a cross-sectional view illustrating a configuration of a LCD 20c which employs a surface light source device 1c. The surface light source device 1c includes a resin frame 3 whose side surface is curved in a concavity manner.

In the surface light source device 1b as illustrated in FIG. 7, a side surface of the resin frame 3 which faces a side surface of the light guide plate 2 is curved. Specifically, the side surface is curved in a convex manner. Light, which has leaked out of the side surface of the light guide plate 2, is directed towards the resin frame 3 and is then reflected from the curved side surface of the resin frame 3 so as to be directed towards the liquid crystal panel 10. Even in a case where a side surface of the resin frame 3 is curved, the light, which has leaked out of the side surface of the light guide plate 2, is directed towards the liquid crystal panel 10. It is sufficient that at least part of a side surface of the resin frame 3 which faces a side surface of the light guide plate 2 is curved with respect to a direction perpendicular to the light exit surface, the curved surface looking towards the light exit surface.

As illustrated in FIG. 8, the surface light source device 1c can include a resin frame 3 whose side surface facing a side surface of the light guide plate 2 is curved in a concave manner. Even in this case, the light, which has leaked out of the light guide plate 2, is reflected from the curved side surface of the resin frame 3 so as to be directed towards the liquid crystal panel 10.

As described above, even in the surface light source devices 1b and 1c, the light, which has been leaked out of the side surfaces of the light guide plates 2, is reflected from the curved surfaces (reflecting surfaces) of the resin frames 3 so as to be directed towards the liquid crystal panel 10. That is, the light, emitted from the light source will be directed to the liquid crystal panel also via a region where the reflecting surface of the resin frame is formed. An area (effective light emitting area 13) of light emitted from the surface light source device 1a is larger than that of the conventional surface light source device. Therefore, the surface light source devices 1b and 1c can still have the effective light emitting areas 13 larger than the active area 12 of the LCD 20 even in a case where respective light guide plates 2 are made smaller in the surface light source devices 1b and 1c than in a conventional one. Since the light guide plate 2 of the surface light source device 1a can be downsized, the surface light source device 1 can have a higher front luminance.

The present invention is not limited to the embodiments, and can therefore be modified in many ways within the scope of Claims. The technical scope of the present invention encompasses embodiments obtained by combining the technical means appropriately modified within the scope of Claims.

### Overview of Embodiments

As early described, the surface light source device of the present invention is configured such that the inclined surface or the curved surface is an entire surface of the at least a side surface.

According to the configuration, the light, which has leaked out of the side surface of the light guide plate, is effectively reflected towards the liquid crystal panel.

The surface light source device of the present invention is configured such that the inclined surface or the curved surface has concavity and convexity.

According to the configuration, the light, which has leaked out of the side surface of the light guide plate, can be reflected from the inclined surface or the curved surface of the frame, while being diffused by the concavity and convexity.

The surface light source device of the present invention is preferably configured such that the frame is made from a white color material.

The surface light source device of the present invention is preferably configured such that the frame is made from a resin or a sheet metal.

According to the configuration, the light, which has leaked out of the side surface of the light guide plate, is effectively reflected towards the liquid crystal panel.

The surface light source device of the present invention is preferably configured such that the light source is a light emitting diode, a semiconductor laser, or a cold cathode fluorescent lamp.

According to the configuration, it is possible to attain a surface light source device which emits light with a high luminance.

Note that particular embodiments or examples discussed in the Detailed Description of the Invention are to be understood as merely clarifying the technical contents of the present invention, and are not to be understood narrowly as being limited to these examples. The particular embodiments or examples can be embodied, with being modified within the spirit of the present invention and the scope of the attached Claims.

### INDUSTRIAL APPLICABILITY

The surface light source device of the present invention is applicable to a portable information device, such as a laptop personal computer, a Personal Data Assistant, a mobile game device, or a mobile phone.

### REFERENCE SIGNS LIST

1, 1a, 1b, 1c, 11 Surface light source device
2 Light guide plate
3 Resin frame
4 Optical frame
5 Reflecting film
6 Bezel
7 Light shielding tape
8 Light source
9 Flexible substrate
10 Liquid crystal panel
12 Active area
13 Effective light emitting area
14 Region
15, 16 Glass substrate
17 Polarization plate
20, 20a, 20b, 20c Liquid crystal display device

1. A surface light source device comprising:
a light source for emitting light;
a light guide plate for guiding the light emitted from the light source so as to direct the light outward via a light exit surface of the light guide plate; and
a frame in which the light source and the light guide plate are housed,
at least part, of at least a side surface of the frame which faces a side surface of the light guide plate, being (i) an inclined surface, which is inclined with respect to a direction perpendicular to the light exit surface or (ii) a curved surface, which is curved with respect to a direction perpendicular to the light exit surface, the inclined surface or the curved surface looking towards the light exit surface.

2. The surface light source device as set forth in claim 1, wherein:
the inclined surface or the curved surface is an entire surface of the at least a side surface.

3. The surface light source device as set forth in claim 1, wherein:
the inclined surface or the curved surface has concavity and convexity.

4. The surface light source device as set forth in claim 1, wherein:
the frame is made from a white color material.

5. The surface light source device as set forth in claim 4, wherein:
the frame is made from a resin or a sheet metal.

6. The surface light source device as set forth in claim 1, wherein:
the light source is a light emitting diode, a semiconductor laser, or a cold cathode fluorescent lamp.

7. A liquid crystal display device comprising a surface light source device recited in claim 1 and a liquid crystal panel.
